(19) United States
(12) Patent Application Publication
(10) Pub. No.: US 2018/0272229 A1
(43) Pub. Date: Sep. 27, 2018

(54) GAME FOR AMUSEMENT AND TEACHING

(71) Applicant: Joan Cappello Tunny, Santa Rosa, CA (US)

(72) Inventor: Joan Cappello Tunny, Santa Rosa, CA (US)

(21) Appl. No.: 15/910,204

(22) Filed: Mar. 2, 2018

Related U.S. Application Data
(63) Continuation-in-part of application No. 14/853,975, filed on Sep. 14, 2015, now abandoned.
Application No. 14/853,975 is a continuation of application No. 13/487,626, filed on Jun. 4, 2012, now abandoned.

(51) Int. Cl. A63F 3/00; A63F 3/04; G09B 19/18; A63F 9/06

(52) U.S. Cl. CPC A63F 3/00063; A63F 3/04; A63F 3/0478; G09B 19/18; A63F 2003/0442; A63F 2003/00996; A63F 2009/0643; A63F 2250/1042; A63F 3/00088

(57) ABSTRACT

An educational board-type game for a plurality of players has world currency as the primary subject matter. The object of the game is to travel the world and earn back the travel expense in 90 days. The game includes a durable, flexible, reusable, portable playing surface, a measuring device, color marker playing pieces and eraser, playing cards, rules, a guide, a log, and a storage cylinder. Players choose destinations and randomly select playing cards that have distance, time and money as transaction values. Players use strategic thinking to determine their moves and calculate foreign currency exchange and borrowing and lending to earn the expense of traveling to choice destinations. A primary intention of the game is to provide an enjoyable recreation activity for social interaction between family and friends. The game is an engaging learning activity for instruction in the social sciences that is programmable for use on an electronic device.

### CROSS REFERENCE TO RELATED APPLICATIONS

This application is a Continuation-in-Part application, filed Mar. 2, 2018, that repeats a substantial portion of and adds and claims additional disclosure not presented in U.S. Continuation application Ser. No. 14/853,975, filed on Sep. 14, 2015, now pending, that incorporated by reference in its entirety, U.S. application Ser. No. 13/487,626, filed Jun. 4, 2012, now abandoned.

### STATEMENT REGARDING FEDERALLY SPONSORED RESEARCH OR DEVELOPMENT

Not applicable

### REFERENCE TO MICROFICH APPENDIX COMPUTER PROGRAM LISTINGS

Not applicable

### BACKGROUND OF THE INVENTION

### Field of the Invention

The present invention relates to a board-type game for amusement that has an educational purpose. The game is for serious game players and for use by students and teaching professionals for classroom instruction and curriculum development in the social sciences. The game is entertaining and involves a level of skill, competition, strategy and content that will enlist serious players. Players have fun, develop learning and strategy skills and gain knowledge in the social sciences, in particular the field of economics. The described embodiment of the present invention is known as Around the World in 90 Days.

### Description of the Prior Art

The use of games for amusement and teaching is well known in the prior art. Serious games represent a billion dollar global market and are used today by organizations as powerful, efficient workforce tools for learning and skill development. (Derryberry, 2007) Students will participate at length in an enjoyable pursuit and the repetition in game playing is a proven learning tool. Is it argued that educators should adhere to repetition a basic learning tool that for centuries has benefitted brains around the globe. (Perry, 2012) Further, it is argued that people learn better by doing something. Educators are placing more emphasis on the design of learning activities rather than teaching activities. Activity based learning focuses on student centered activities that include interaction between the learner and an environment with resources. A high quality game is an engaging activity that allows for the participation, interaction and communication called for by this new instructional theory. Games can be used inside and outside scheduled classrooms as student centered activities that will lead to deeper and more meaningful understandings. Students learn content, develop their own meanings and construct new ideas. (Walker and Ryan, 2005) When content is viewed in different ways, students strengthen and expand their knowledge of the particular subject matter presented. The game of the present invention combines repetition with an entertaining learning activity. The preferred embodiment of the game of the present invention is an apparatus that reinforces the retention that comes with repetition and allows for creative thinking. The described embodiment of the present invention improves on the prior art by providing a new and improved game.

Academics argue that the subject matter that comprises the social sciences is the single most important source for practitioners writing games. (McGowan, 2010) The social sciences differ from the physical sciences and, for the sake of better knowledge of why people behave the way they do, must value and use their own models. They are mature disciplines with no need to emulate other sciences. (Clark and Primo, 2012) For this reason, they are especially suited to game playing. Games contribute to education and training as a life-long process. The described embodiment of the present invention acknowledges the history and the popularity of games as educational tools and teaches how amusement can be used as a resource to bring the wealth of information in the social sciences to the general public through games. The present invention can be used by teachers to enhance any social studies curriculum where game players can compete in achieving an objective that can be measured and requires quantifiable resources to attain. For example, the described embodiment is specifically intended to bring about a common understanding of international economics as it relates to currency exchange, borrowing and lending. The game could focus on an understanding of the terms of trade and the most abundant resource of world countries. The present invention improves on the prior art in that it utilizes the social sciences to provide an enjoyable, entertaining and challenging game for amusement and for use as a serious educational tool that would otherwise be unavailable and that produces unexpected results. The game of the present invention through amusement contributes to human development, maturation, and learning. It imparts knowledge to the people that will lead to informed citizen participation in public decision making and to a better world.

### Game Design

Most game boards are designed with grids of squares or divided into defined spatial paths with playing pieces that have specific identities. Players must move along a predetermined path overcoming obstacles to reach the end square and win the game. Most educational games teach a specific lesson relating to facts with reinforcement for correct answers. By way of example, U.S. Pat. No. 324,535 (Clemens, 1885) is for a game apparatus designed as a chart with columns and rows and holes for placement of pegs. The purpose is for amusement and instruction, specifically to help players remember important historical dates. More recently, U.S. Pat. No. 6,102,398 (Kolleth, 2000) is a board game that has a map and path around which players progress based on answering fact questions correctly. The questions and answers are provided on cards. Similarly, U.S. Pat. No. 2,026,082 (Darrow, 1935) is a game board with forty spaces extending entirely around the perimeter of the board. Players follow this continuous path, moving their symbols according to throws of dice. The board provides a track for continuity. The game teaches trading, specifically in real estate, and presents business situations simulating those occurring in real life. The object of each player is to force the other players to quit the game because they cannot meet their financial obligations, leaving one player the winner. U.S. Pat. No. 3,939,578 (Coffey, 1976) is an educational board game designed as a tutorial system of learning specific academic subject matter that includes cards, tokens and chance means. The board is divided into academic subject areas and the cards correspond to these areas. Players move through defined numbered spaces on the periphery of the board based on the chance means and answer the questions on the board or cards that correspond to the defined spaces. Modern games are using technology or computers, popular mediums that are able to engage people for extensive periods of time. U.S. Pat. No. 6,641,400 (Kennedy, 2003) is a multi-disciplinary educational tool that is also suitable for entertainment that can include a playing board with spaces and playing dice that determine user movement on the spaces. The educational tool combines using all the senses, including sight, sound, touch and smell, and educational experiences within a single activity that teaches subject matter by simulation and can be played on a computer by one user.

The present invention is designed to promote serious learning through organized games and play. An intention is to show how games can be effective learning environments when creatively integrated into a curriculum. The game apparatus is an efficient teaching tool. A new substrate for board-type games enables teaching and demonstration. A primary intention is to provide an enjoyable recreation activity for social interaction between family and friends through a board-type game apparatus that is especially efficient in small living spaces. Another intention is to promote this activity and social interaction by providing an inexpensive, durable, reusable, portable game apparatus. Acknowledging the expense of acquiring the new technology games and the technical support for maintenance, the present invention can be easily translated into software for use on a computer by a plurality of players. The experience, reflection, questioning and discussion that come with group interaction are important parts of learning. An important aspect of the present invention is having a community that develops around the game. Game community mirrors the definition of an educational community of practice. Players bring diverse experience and are valued for their contributions as the group continually advances in knowledge and skills. (Oblinger, 2006) The game of the present invention provides a framework that supports developing new knowledge through social interaction. Rather than providing a fixed game board path for lessons or instruction, the game board-type surface of the present invention allows players to determine and mark their own spatial path on a board-type surface with an identifiable image. It provides all the possible positions and allows players to create a new spatial location each round. The timeframe for game playing is flexible. The game can be played as one timed game session of eighteen rounds with a high score winner or as a series of game sessions with players building on their score in the prior game. It teaches basic concepts in the social sciences, requires skill and strategic thinking and encourages creativity. The game components of the present invention are constructed of a paper like material that adheres to most surfaces in a vertical or horizontal position. The new structure improves on the prior art that restricts players to a table and chairs and game chance determined moves with predetermined spaces. The design of the present invention combines the ingredients necessary for serious games.

### Game Content

Modern games are criticized as having insipid content, being too teaching focused or being too concerned with entertainment utility. By way of example, U.S. Pat. No. 6,079,710 (Brown, 2000) is a bingo-type game to teach basic mathematics. U.S. Pat. No. 5,478,076 (Aylett, 1976) relates to a theme park. Users are entertained by traversing the attractions and structures of a theme park. The present invention builds on a basic economic concept, the covered interest differential. In large international financial transactions this involves securing a foreign loan with a forward foreign exchange currency contract. It is a conventional rule for reducing the foreign exchange risk that comes with fluctuating exchange rates. (Linden and Kindleberger, 1982) The game uses variables from the covered interest differential, foreign currency, interest rates and time, as the means by which players earn back the money expense of traveling the world.

The content of the preferred embodiment of the game as described herein engages players in fun activity and achieves serious, measureable and sustainable learning results. Learning is an intentional outcome of the present invention. In the preferred embodiment, players gain an understanding of economics. People love the excitement of travel to exotic places. While millions of dollars are spent each year in international travel and tourism has become a major component of the world economy, most Americans do not have passports and do not travel abroad. Americans spend most of their leisure time at home. Attributed to many factors, i.e., the work ethic, the hassle and expense of air and auto travel, Americans prefer to spend time at home interacting with family and friends. Sales of board games in recent years were in the hundreds of millions of dollars. Over 250 million sets of the popular game of monopoly have been sold worldwide. In the described invention, game players travel to choice destinations on each of the seven continents. The game enlists players with the prospect of visiting interesting and exotic destinations around the world while adding value to these destinations. It provides a peaceful, enjoyable pursuit, in a relaxing atmosphere as it develops learning skills and encourages new understandings of important concepts, creative thinking and decision making.

Most educational games that develop skill in collecting data, planning and strategic thinking, such as the many chess and war games, do so in a conflict environment with the goal of destroying the enemy or dominating opponents. The popular war game Stratego and other modern conflict games of strategy are based on French Patent No. 396,795 (Edan, 1909). Edan teaches strategy through a war game played on a board divided into squares with game pieces representing different military ranks. U.S. Pat. No. 1,144,927 (Wunsch, 1915) is a board game for all ages. The board depicts Germany, Russia, Austria, Belgium, Turkey and France, battle strategies and fields of battle. Objectives are to be interesting and instructive while capturing your opponent's flags. U.S. Pat. No. 5,026,070 (Watt, 1991) is a strategic naval warfare game played on a checker-style board with the object of capturing an opponent's naval bases. U.S. Pat. No. 6,209,873 (DeGeorge, 2001) teaches strategic and tactical decision making by simulating real combat scenarios. U.S. Pat. No. 6,981,700 (Syed, 2006) is a turn-based strategic board game similar to chess and checkers with the strategy of attack and defense improved only in difficulty to be more competitive and thereby enjoyable to players.

The content of the preferred embodiment of the present invention is entertaining and useful in that it is an enjoyable activity that teaches social studies concepts important to everyday living and involves strategic thinking without conflict. Similar to chess-type games, knowing the rules and strategies are only a beginning. There is so much to learn through this game that over a lifetime players will still discover new understandings and new ways to improve their play. In the described embodiment of the present invention, players add value to their choice travel destinations. As tourists, they must purchase each choice destination's currency to cover the travel expense. Players travel the world and develop strategies that involve time, distance and money to earn back the expense of their trip. In so doing, they collect the information they need, plan their moves and use strategic thinking while they expand their knowledge of the social sciences as it relates to present day international currency exchange.

Evident in the aforementioned patents there are many games involving boards and cards and requiring skills and strategy with the object of teaching. The present invention preserves the entertainment aspect of games so as to engage players in activity that expands their knowledge base and changes nonproductive skills and beliefs. The present invention has the amusement value of a game of monopoly and chess and the learning value called for by the internationalization of the world economy. The board-type game of the present invention substantially departs from the conventional content and design of the prior art and in so doing provides a new and improved apparatus for the purpose of amusement and teaching.

### BRIEF SUMMARY OF THE INVENTION

The general purpose of the present invention is for players to enjoy with others an amusing game and to make subject matter in the social sciences interesting and understandable to the ordinary person. One of the most significant events of recent years has been the internationalization of the world economy. The massive movement of goods, labor and money across national borders makes it imperative that the ordinary person understand basic principles of economics that apply worldwide. While citizenship education, the basis of mandatory schooling in the United States, requires an understanding of a free market economy, economics is not a required subject in public schools. The transformation in society is having an impact on teachers and learners and on the learning environment in all sectors. Educators worldwide are placing more emphasis on the design of learning activities to include a wider range of practices that focus more on learner activity than teacher activity and that lead to planned outcomes. Therefore, it can be appreciated that there exists a need for a new and improved game of amusement that is a teaching tool for learning important concepts that apply to our everyday lives and developing creative thinking.

The described embodiment of the present invention is for serious game players and for learning and curriculum development in economics. Game players experience currency and solve problems in a new way. The described game apparatus can be used to supplement and enhance social studies curriculum with subject matter adaptable to a game where game players compete in achieving an objective that can be measured and requires quantifiable resources to attain. The present invention is a game for amusement that engages players in a fun activity while teaching concepts relating to current events, an activity that would otherwise be unavailable.

The components of the board-type game in the described invention are flexible, durable, adherent, printable, reusable and portable. They include a playing field surface, a measuring device, playing cards, rules, a game guide and a game log permanently printed with the game method and content. The playing pieces are erasable color markers. The game components roll into a three compartment cylinder for storage and carrying. A plurality of players visit choice tourist destinations and learn about the currencies unique to countries around the world. Players use strategic planning to choose and execute their route of travel. Players select choice DESTINATION CARDs and randomly choose CURRENCY, INTEREST RATE and BONUS PENALTY CARDs. Players measure their travel distance in miles, calculate the expense per mile of their travel and combine the values on their hand of cards with values in the TRAVEL GUIDE to determine earnings possibilities in order to earn their trip expense. To this end, players buy and borrow, sell and lend foreign currency. The player best able to comprehend the many possibilities present in their hand of cards and to transact in the most efficient way wins. Skill is developed with continued play as players learn the process and the card possibilities. In this regard, the present invention substantially meets the need for a new and improved game for serious game players.

The educational focus of the present invention combines an efficient teaching tool with subject matter and learning skills such as collecting information, planning and strategic thinking making the game a serious opportunity for learning in the social sciences, in particular economics. The social sciences are not just about understanding subject matter. They are about understanding people and cultural similarities and differences. The game of the present invention is an opportunity for play to become an important contributor to human development, maturation, and learning. The learning techniques found in the present invention, primarily activity, repetition, immersion and reflection, are valuable learning tools that can be applied to the social sciences. The present invention improves on the prior art for games that relate to single subjects and reward memorization. It builds on the best of the prior art to include the many ingredients of serious games. The game of the present invention as described is a board-type game. It can also be developed as a digital game for use with an electronic device such as a computer. The present invention therefore fills the need for a new and improved game of amusement that would otherwise be unavailable.

### BRIEF DESCRIPTION OF THE SEVERAL VIEWS OF THE DRAWINGS

The foregoing brief summary of the invention describes a board-type game for amusement that is challenging and engaging and can be used as a powerful, relevant learning tool. The game components demonstrate and teach the learning objective of the game. This and other intentions will become more apparent in the following detailed description. Such description refers to the annexed Drawings wherein:

FIG. 1 is a perspective view of the preferred form of the game board-type apparatus as a whole including playing field surface, measuring device, playing cards, Rules of the Game, Travel Log, Travel Guide and player color marker pieces and eraser.

FIG. 1A is a perspective view of the cylindrical tube for packaging, storing and transporting the game.

FIG. 1B is a plan view of the playing field surface measuring device.

FIG. 1C is a plan view of the player color marker pieces and eraser.

FIG. 1D is a plan view of a region of the playing field surface showing a spatial path as measured and marked by four players in one round of play.

FIG. 1E is a plan view of the game Travel Log, Rules of the Game and Travel Guide.

FIG. 2 is a plan view of four choice cards in the preferred form of the game.

FIG. 3 is a plan view of four chance cards in the preferred form of the game.

FIG. 4 is a plan view of a one player's hand of five cards in one round of play in the preferred form of the game.

FIG. 5 is a Data Flow Diagram representation of the preferred form of the game board-type apparatus playing system.

The foregoing advantages, features and devices are apparent in the following detailed description, drawings and claims.

### DETAILED DESCRIPTION OF THE INVENTION

The following detailed description explains the best mode of making and using the present invention, an entertaining, educational game for two or more players with the earth's surface and currency as the primary subject matter. Time, distance and money are used to determine strategies for traveling around the world. The purpose of the game is for players to have fun visiting choice destinations around the world. The challenge is competing to be the first to travel to the seven continents and earn back the expense of the travel. A further purpose of the game is for players to learn economics, in particular, the supply and demand and exchange value of currency. To better understand the disclosure and to provide information that can be used for the physical design of the board-type game apparatus and of a software program compatible with an electronic device such as a computer, the following terms and intentions as they relate to the present invention and are employed in the specification and claims are explained.

The term social science refers to a plurality of fields including: anthropology, archaeology, business administration, communication, criminology, economics, education, government, linguistics, international relations, political science, sociology and, in some contexts, geography, history, law, and psychology.

The terms supply and demand mean the exchange volume of the currency of the world.

The term interest rate means the cost of or return on having access to currency for a given period of time.

The term foreign exchange rate means the rate at which currency conversion takes place, the difference in value between the US dollar and a foreign country currency.

The term spot rate is the rate at which currency conversion takes place, the value of a foreign currency in US dollars, that changes daily.

The term forward exchange rate is the conversion value at a future date of a foreign currency in US dollars that is agreed upon when a contract for exchange is made.

The term currency exchange market means the interaction of people trading currencies for various reasons.

The term forward exchange contract means a binding agreement to buy or sell a country currency at a specified rate on a future date. A forward contract requires 10% of the total contract amount at the time of contract with the remainder payable when the contract is due.

The term cross-currency exchange rate means the rate at which one foreign currency is converted to another foreign currency without having to first convert either currency into US dollars.

The term arbitrage means a transaction involving three currencies, two foreign and US dollars, where gains can be made when currency exchange rates do not exactly match up. As one of the steps you must always be selling one foreign currency for another foreign currency.

An intention of the game is to provide a peaceful, relaxing, enjoyable social learning environment where players use strategic planning in determining real world non-militaristic moves. Rather than movement of attack and defense on a predetermined grid, players create their own spatial path on a portable, reusable, adherent board-type surface playing field and in a collective effort add value to the countries they visit by spending money at each destination. At the same time they maintain and enhance their own value as they earn the travel money they spend through currency exchange.

An intention of the described embodiment of the present invention is to make game playing more worthwhile, challenging and interesting by providing activity centered instruction in the social sciences to the general public.

An intention of the game is to make classroom learning more exciting by giving intermediate, secondary and college level teachers an interactive, engaged learning activity that they can customize with social science content at different levels of difficulty.

To accomplish these intentions, game players utilize the game apparatus described in the annexed ten sheets of Drawings.

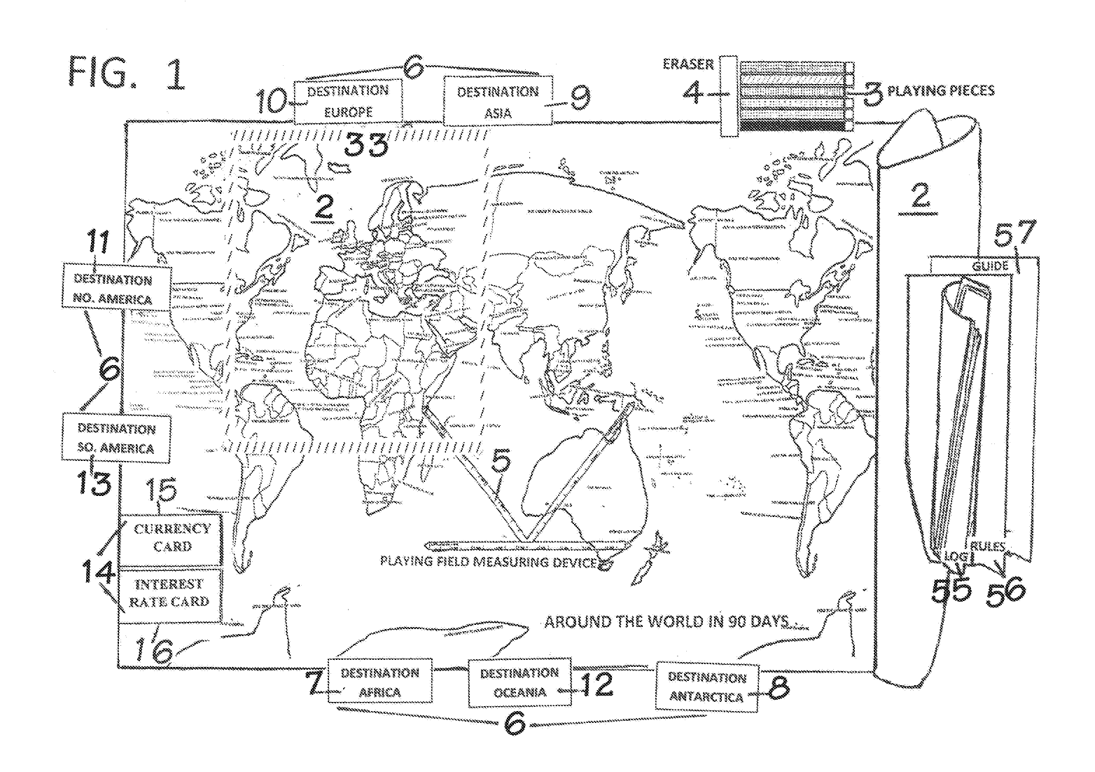

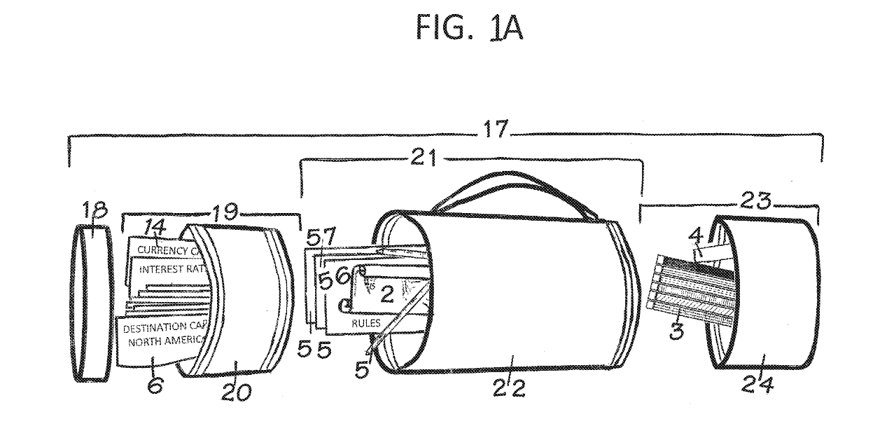

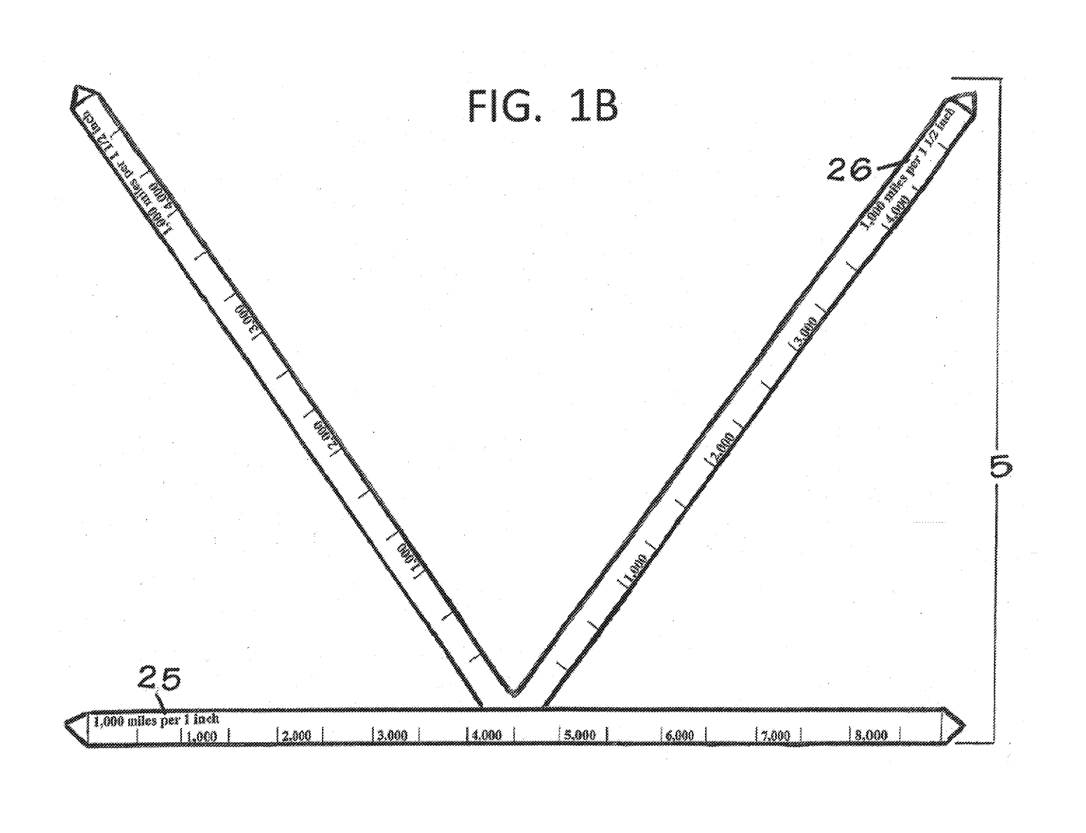

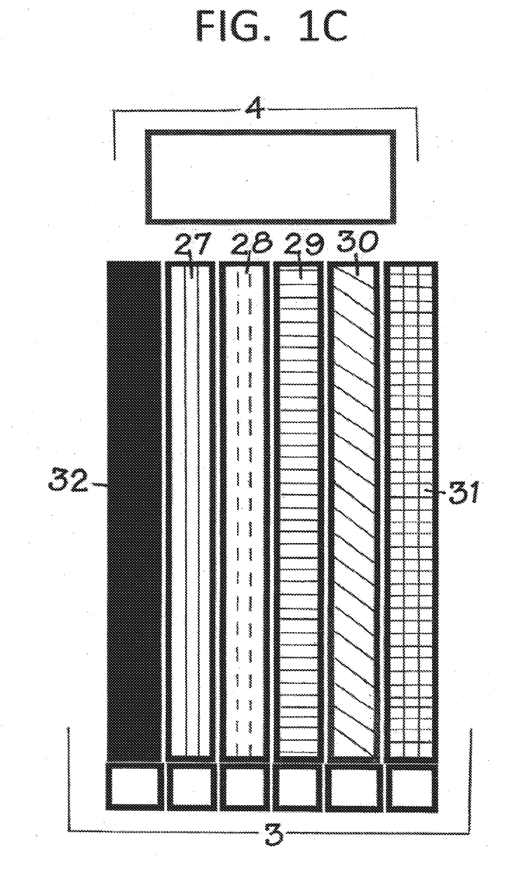

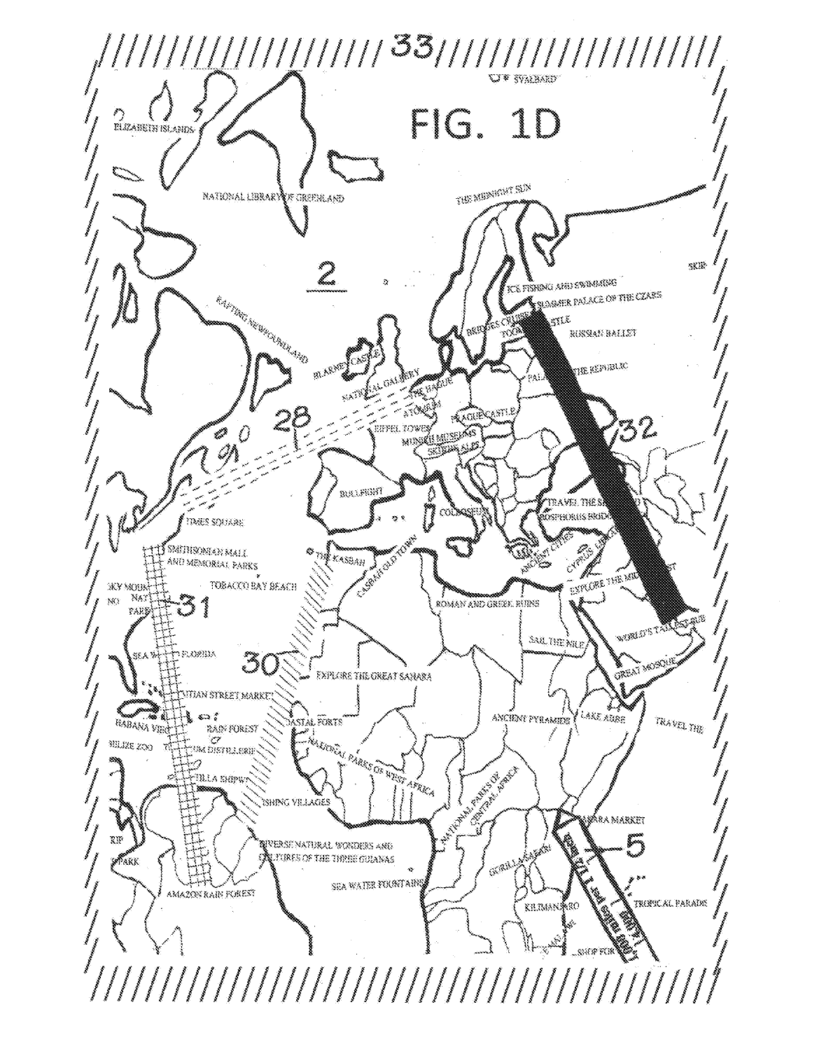

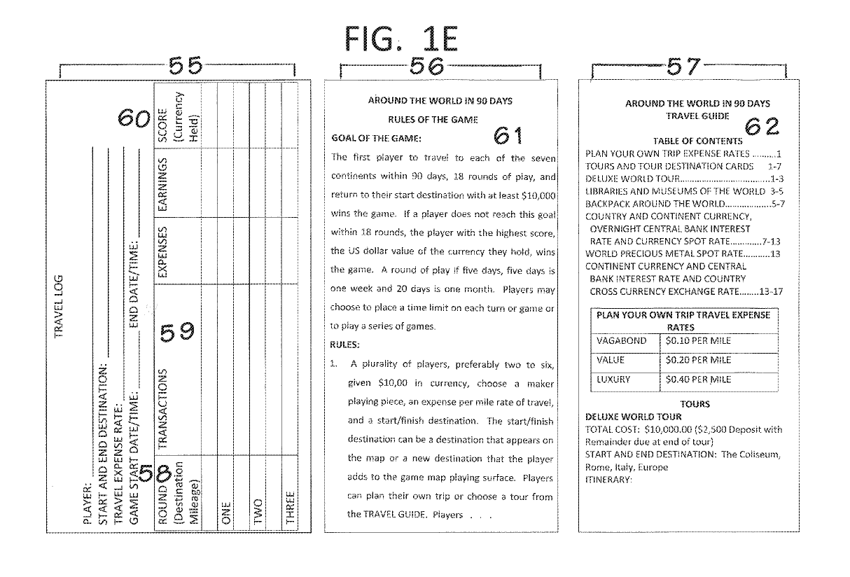

Reference is now made to the drawings, FIGS. 1 through 5, designating a new board-type game for serious game players with an educational purpose.

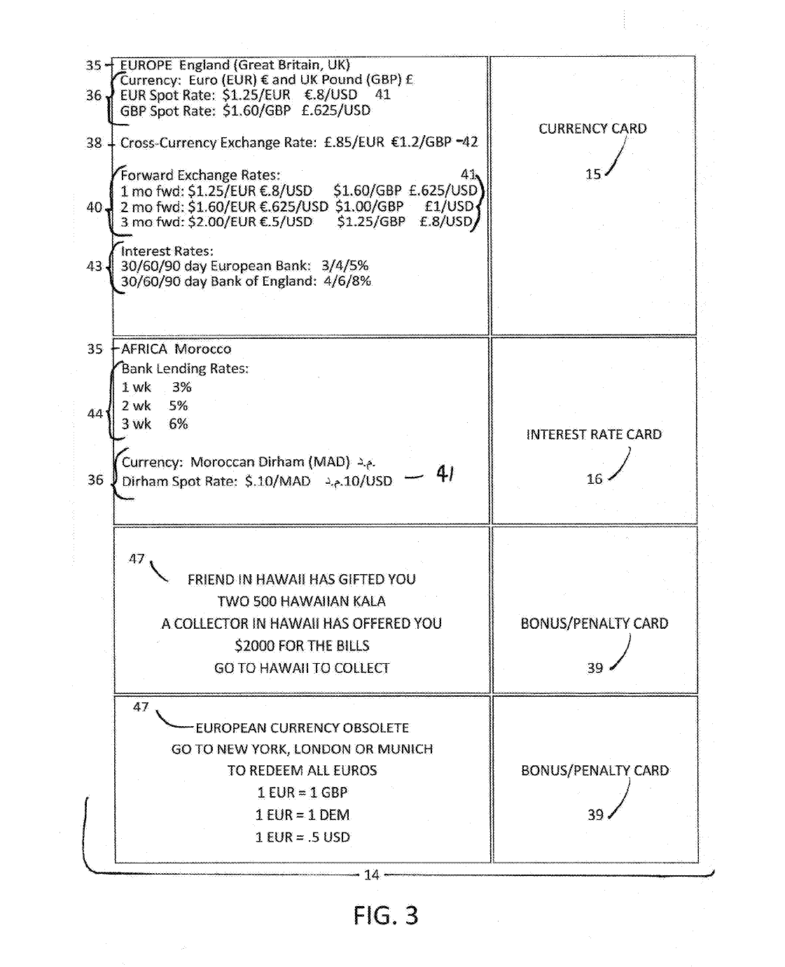

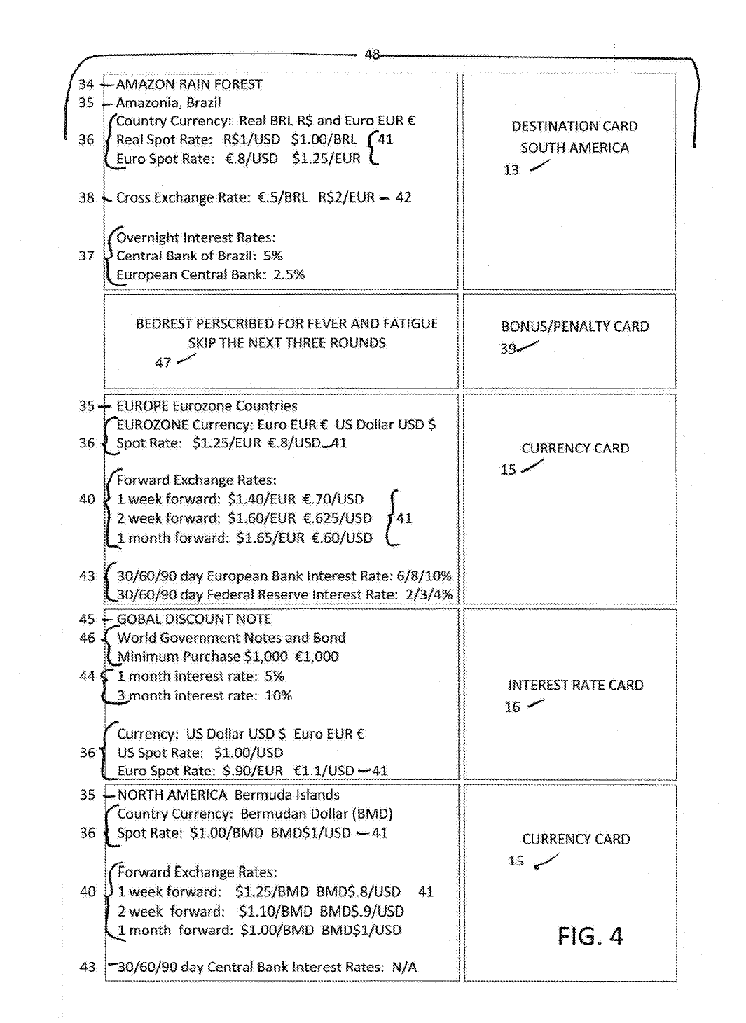

FIG. 1 The preferred form of the present invention is a board-type game apparatus. The game playing field surface is of a rectangular shape, generally indicated at numeral 2. The construction material, an adherent, markable, flexible treated polypropylene film, is printed with a permanent graphic of a world map. The size of the world map approximates the circle distance around the earth, 25,000 miles, in inches. Continents are depicted in a flat, continuous array, one full view and one half view, so that distance can be measured from left to right or right to left. Locations on the DESTINATION CARDs, generally designated by numeral 6, and the destinations in the tours in the TRAVEL GUIDE are on the playing field surface map. The Playing Field surface, indicated by numeral 2, Measuring Device, indicated by numeral 5, TRAVEL LOG, indicated by numeral 55, RULES OF THE GAME, indicated by numeral 56, and TRAVEL GUIDE, indicated by numeral 57, are made of the same treated polypropylene film. Players can add destinations to those depicted on the map and mark their travel path on the map with their playing piece, indicated at numeral 3, six markers of different colors. The marked surface is erasable with the eraser, indicated at numeral 4. The map measuring device, indicated at numeral 5, shown adhered to the playing field surface, is configured to measure the playing field surface. The game playing choice DESTINATION CARD, numeral 6, is identified on the first side by continent. AFRICA, indicated at numeral 7, ANTARCTICA, indicated at numeral 8, ASIA, indicated at numeral 9, EUROPE, indicated at numeral 10, NORTH AMERICA, indicated at numeral 11, OCEANIA, indicated at numeral 12, and SOUTH AMERICA, indicated at numeral 13. The chance cards, generally indicated by numeral 14, are identified on the first side as CURRENCY CARD, indicated at numeral 15, and INTEREST RATE CARD, indicated at numeral 16. Chance cards identified on the first side as BONUS PENALTY CARD, indicated at numeral 39 in FIGS. 3 and 4, are mixed into the chance card decks, 14. The card decks have transaction values on the second side. The card decks are shown value side down on the board-type game surface, number 2. The cards are made of the same treated polypropylene film.

FIG. 1A The game packaging and storage cylinder, generally designated by numeral 17, is made of a light weight durable, rigid, portable material, such as aluminum and plastic. The game cylinder includes a top circular piece, indicated at numeral 18, a closure with grooves that screw onto a top cylinder, generally designated by numeral 19. The top cylinder is a tube, indicated at numeral 20, of sufficient size to store the game playing cards, 6 and 14. Tube 20 has grooves at the bottom that screw into the top of the central cylinder, generally designated by numeral 21, a tube with a handle, indicated at numeral 22, of sufficient size to store the flexible playing field surface, indicated at numeral 2, and measuring device, indicated at numeral 5, the RULES, indicated at numeral 56, TRAVEL GUIDE, indicated at -numeral 57, and TRAVEL LOG, indicated at numeral 55. A bottom cylinder, generally indicated at numeral 23, is a tube, numeral 24, of sufficient size to store the player marker pieces and eraser, indicated at numerals 3 and 4. Tube 24 has grooves on the top that screw into the bottom of the central tube, 22. This game packaging cylinder allows for ease of packaging, storing and transporting the game.

FIG. 1B The Playing Field Measuring Device, generally designated by numeral 5, is made of the treated polypropylene material. It adheres to the surface and is detachable. Players use the device, a linear measure of circular distance, to measure their distance as they travel around the world. In the described embodiment of the present invention, the device is permanently marked with units that measure distance on the playing field surface, 1000 miles per inch horizontally, indicated at numeral 25, and 1,000 miles per one and one half inch diagonally, indicated at numeral 26. The device measures the real world distance in miles between locations on the world map. The tool can be adapted to different map sizes. Players calculate the expense of each round of travel by multiplying the miles traveled by the travel cost per mile they select from the TRAVEL GUIDE, FIG. 1E, 62, Vagabond at $0.10 per mile, Value at $0.20 per mile and Luxury at $0.40 per mile.

FIG. 1C The playing pieces, generally designated by numeral 3, include marker piece blue, indicated at numeral 27, marker piece purple, indicated at numeral 28, marker piece red, indicated at numeral 29, marker piece green, indicated at numeral 30, marker piece yellow, indicated at numeral 31, marker piece black, indicated at numeral 32, and a marker eraser, generally indicated by numeral 4. Players use their playing piece to mark their travel route and to clear the game components each game of play. Individual players are identified by their playing piece, 27, 28, 29, 30, 31 and 32, and their route can be easily followed during the game. The playing pieces can be erasable markers or rolls of differentiated strips constructed from the treated polypropylene film.

FIG. 1D A view of a spatial area, generally designated by numeral 33, on the playing field surface map, 2 in FIG. 1, illustrates the method of the game. The area on the map is marked with four player paths, player purple, 28, player green, 30, player yellow, 31, and player black, 32. In this round, player purple is traveling from TIMES SQUARE in New York City, NORTH AMERICA, to the NATIONAL GALLERY in London, EUROPE, a measured distance of 3,500 miles. Player purple, 28, has chosen from the TRAVEL GUIDE, 57 in FIG. 1E. Luxury trip expense of $0.40 a mile, 62 in FIG. 1E. Distance multiplied by expense rate equals a travel expense of $1,400. Player yellow, 31, is traveling from the SMITHSONIAN MALL in Washington, D.C., NORTH AMERICA, to the AMAZON RAIN FOREST, Amazonia, SOUTH AMERICA, a distance of 3,000 miles. Player yellow, 31, has chosen Vagabond trip expense of $0.10 a mile for a travel expense of $300. Player green, 30, is traveling from THE THREE GUIANAS. Suriname, SOUTH AMERICA, to CASABLANCA, Morocco, AFRICA, a distance of 3,600 miles. Player green, 30, has chosen Value trip expense of $0.20 a mile for a travel expense of $720. Player black, 32, is traveling from the SUMMER PALACE OF THE CZARS, St. Petersburg, EUROPE/ASIA, to the THE WORLD'S TALLEST BUILDING, Dubai, ASIA, a distance of 2,700 miles. Player black, 32, has chosen Luxury trip expense at $0.40 a mile for a travel expense of $1,080. Each player has recorded on their TRAVEL LOG their round destination, the measured travel mileage and expense, and their score, 58, 59 and 60 in FIG. 1E.

FIG. 1E TRAVEL LOG, RULES OF THE GAME AND TRAVEL GUIDE are printed on the treated polypropylene material. The TRAVEL LOG, generally designated by numeral 55, is a permanent and erasable markable ledger wherein each player identifies their objective, numeral 58, expense and earnings transactions, numeral 59, and their score, numeral 60. The log serves to evaluate game play and learning. The RULES OF THE GAME, generally designated by numeral 56, are permanently marked, numeral 61, with the method of the game. The TRAVEL GUIDE, generally designated by numeral 57, is permanently marked with the game playing system data, numeral 62.

TRAVEL LOG, generally designated by numeral 55, is configured as follows:

RULES OF THE GAME, generally designated by numeral 56, illustrate the method of the preferred embodiment in the described invention. The rules also include the definition of terms and explanation of card rates and values as described herein. Game strategies and a scenario of a player's transactions from one hand of cards are included as follows:

Game Strategies:

Players can choose a destination illustrated on the playing field surface, mark a new destination on the map or choose a tour from the TRAVEL GUIDE. Players choose a hand of five cards, one choice DESTINATION CARD for their chosen destination, two chance interest rate cards, and two chance currency cards. Players maximize earnings by following the transaction rule of buy and borrow low, sell and lend high.

Scenario for a Player:

Player has chosen the Deluxe World Tour at a cost of $10,000. $2,500 down and $7,500 due in 90 days with a start and finish destination in Rome, Italy.

Player's Round ONE hand of cards is as follows:

| | |
|---|---|
| VISIT THE COLISEUM | DESTINATION |
| Rome, Italy | CARD EUROPE |
| Currency: Lira ITL £ and Euro EUR € | |
| Spot Rates: | |
| ITL: £1450/USD $.0007/ITL | |
| EUR: €.8/USD $1.25/EUR | |
| Cross currency Exchange Rate: | |
| €.0005/ITL £1925/EUR | |
| Central Bank Overnight interest Rate: 6% | |
| PALACE OF THE REPUBLIC | DESTINATION |
| Minsk, Belarus | CARD EUROPE |
| Currency: Belarusian Rouble BYR Br | |
| Spot Rate: Br10000/USD $.0001/BYR | |
| Belarus Central Bank Overnight interest Rate: 12% | |
| EUROPE | CURRENCY |
| EUROZONE COUNTRIES | CARD |
| Currency: Euro EUR € | |
| Spot Rate: $.50/EUR €2/USD | |
| Forward Exchange Rates: | |
| 1 mo: $.55/EUR €1.8/USD | |
| 2 mo: $.625/EUR €1.65/USD | |
| 3 mo: $.50/EUR €2/USD | |
| 20/40/60 day European Bank Interest Rates: 5/10/5% | |
| ASIA | CURRENCY |
| MAINLAND CHINA | CARD |
| Currency: Renminbi Yuan CNY ¥ | |
| Spot Rate: $.16/CNY ¥6.25/USD | |
| Forward Exchange Rates: | |
| 1 wk: $.20/CNY ¥5/USD | |
| 2 wk: $.25/CNY ¥4/USD | |
| 5/10 day Chinese Interest Rates: 16/25/% | |
| NORTH AMERICA | INTEREST RATE |
| UNITED STATES | CARD |
| Treasury Notes | |
| Interest Rate: | |
| 1 wk: 3% | |
| 2 wk: 5% | |
| 3 wk: 10% | |
| Currency: US Dollar USD $ | |
| Spot Rate: $1.00/USD | |
| SECURITY DELAY AT EASTERN EUROPE | BONUS/PENALTY |
| BORDER CROSSING | CARD |
| PASSPORT AND LUGGAGE CONFISCATED | |
| FOR VERIFICATION AND SEARCH | |
| SKIP THREE ROUNDS | |

Player's BONUS PENALTY card has eliminated her from the DELUXE WORLD TOUR. She cannot be at the next destination in in ten days. Player decides to continue in the game by planning her own trip and traveling to Belarus in Round FOUR and choose a destination card for this location. She can use the values on the destination card to buy BYR spot and lend in Belarus for 12% interest earnings to earn back the travel expense. In Round ONE she can use her tour destination card to buy ITL spot and lend in Italy for 6% interest earnings, she can buy EUR at the spot rate on the currency card and exchange for ITLs to increase these earnings. She can sell EURs forward and earn both interest and the forward premium in Round ONE and TWO. She can do the same with CNY buying forward and selling spot in Round TWO. She can invest in US Treasury Notes for interest earnings.

Player's Travel Log records her transaction decisions and score:

PLAYER: GREEN
START AND END DESTINATION: TOUR/BELARUS EUROPE
TRAVEL EXPENSE RATE: $.20 per mile
GAME START DATE/TIME: SAT 5:00 PM END DATE/TIME:

| ROUND | | | | |
|---|---|---|---|---|
| (5 Days) | | EXPENSE | | SCORE |
| Destination | TRANSACTION | (travel and | | (currency in |
| Travel Miles | (Buy, Sell, Borrow, Lend) | transaction) | EARNINGS | hand) |
| Round ONE | Travel | $2,500. | | $10,000. |
| DELUXE | Buy 1485 EUR @ $.50 | $742.50 | | |
| WORLD TOUR | Exchange for 2,860,000 ITL | | | ITL2,860,000 |
| Rail Trip Eastern | Sell ITL @ $.0007 | | $2,000. | |
| European | Buy 30,000 CNY @ $.16 | $4,800. | | CNY30,000 |
| Countries-10 | Sell CNY 2 wk. fwd. | | | |
| days | @ $.25 | | | |
| SKIP | | | | |
| ROUND TWO | Buy $5,000 3 wk US notes | $5,000. | | $3,957.50 |
| SKIP | @ 10% | | | |
| | Sell CNY | | $7,500 | |
| ROUND THREE | | | | $6,457.50 |
| SKIP | | | | |
| Round FOUR | Travel | $2,000. | | $10,557.50 |
| Europe | Buy 50 million BRL spot @ | $5,000. | $5,600. | |
| Belarus | $.0001 and lend overnight @ | | $5,500. | |
| 1,000 miles | 12% | | | |
| | Redeem US Notes | | | |

TRAVEL GUIDE, generally designated by numeral 57, illustrates the game playing system data. As described herein, this includes the following quantitative data.

Currency and interest rates for the continents and countries of the world from Afghanistan to Zimbabwe, numeral 62, 7-13, include:

WORLD OVERNIGHT INTEREST
RATES AND CURRENCY SPOT RATES

| DESTINATION/ | | CURRENCY(USD/ |
|---|---|---|
| CURRENCY | | FOREIGN and |
| CODE SYMBOL | INTEREST | FOREIGN/USD) |
| Afghanistan/Afghani AFN [symbol] | 12% | $.02/AFN [symbol] 50/USD |
| Africa/Afro AFR | 5% | $.10/AFR AFR10/USD |
| Albania/Albanian Lek ALL L | 13% | $.02/ALL Lek 50/USD |
| . . . | . . . | . . . |
| Yemen, Rep./ | 18% | $.004/YER [symbol] 250/USD |
| Yemen Riyal YER [symbol] | | |
| Zambia/Zambian Kwacha | 10% | $.0002/ZMK ZK5,000/USD |
| ZMK ZK | | |
| Zimbabwe/Dollar ZWK | 150% | $.0025/ZWK ZWK400/USD |

WORLD SPOT RATES FOR PRECIOUS METALS, numeral 62, page 13, include:

| | |
|---|---|
| GOLD XAU | $1524 PER OZ |
| | €1189 PER OZ |
| PLATINUM XPT | $1405 PER OZ |
| | €1097 PER OZ |
| SILVER XAG | $27.55 PER OZ |
| | €21.5 PER OZ |
| COPPER | $4.00 PER LB |
| | €3.3 PER LB |

Hypothetical continent currency spot rate and central bank overnight interest rate and participating country cross-currency rates, numeral 62, 13-17, include:

AFRICA—CURRENCY: AFRO AFR includes rates for 11 countries Egypt through Uganda.

### CENTRAL BANK OF AFRICA OVERNIGHT INTEREST RATE 5%

### AFR SPOT RATE: $0.10=1 AFR 10 AFR=1 USD

| | |
|---|---|
| EGYPT 12% | TANZANIA 12% |
| $.20 = 1 EGP | $.000625 = 1 TZS |
| EGP .625 = 1 AFR | TZS 185 = 1 AFR |

EUROPE—CURRENCY: EURO EUR € includes rates for 20 countries, Austria through Ukraine.

### EUROPEAN BANK OVERNIGHT INTEREST RATE 3%

### EURO SPOT RATE: $0.80/EUR €1.2/USD

| | |
|---|---|
| ITALY 3% | UKRAINE 20% |
| $.000625 = 1 ITL | $.12 = 1 UAH |
| ITL 1900 = 1 EUR | UAH 9 = 1 EUR |

NORTH AMERICA—CURRENCY NORTH AMERICAN DOLLAR NAD includes rates for 21 countries, Bahama Islands through United States.

### CENTRAL BANK OF NORTH AMERICAN OVERNIGHT INTEREST RATE: 1.5%

### NAD SPOT RATE: $0.625=NAD 1.6 NAD=USD

| | |
|---|---|
| UNITED STATES 1.5% | BAHAMA ISLANDS NA % |
| $1.00 = 1 USD | $1.00 = 1 BSD |
| USD .625 = 1 NAD | BSD .625 = 1 NAD |

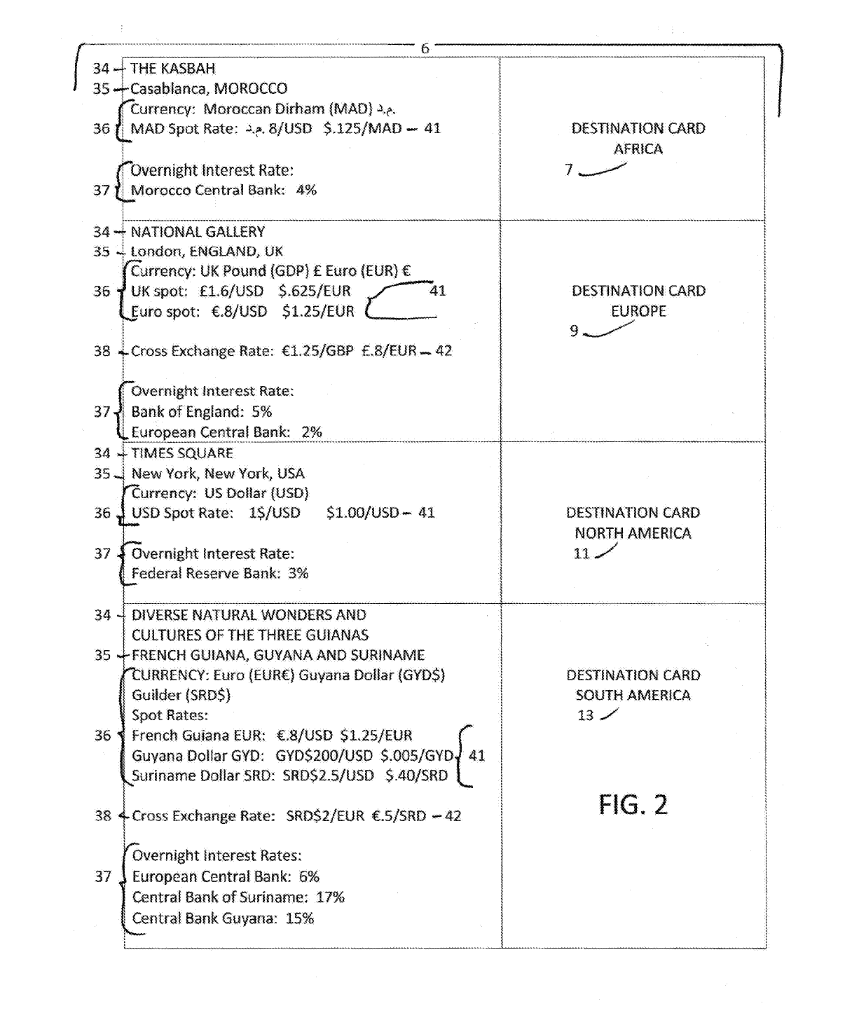

FIG. 2 Four choice DESTINATION CARDs, generally designated by numeral 6, are permanently marked. The first side of the card identifies the continent, AFRICA, 7, EUROPE, 9, NORTH AMERICA, 11, and SOUTH AMERICA, 13. The second side of the card identifies the tourist attraction, 34, the location, 35, the country currency(s) and spot rate(s), 36, and the country central bank overnight interest rates, 37. DESTINATION CARD currency and spot rates, 36, can include more than one currency as on the cards for EUROPE, 9, and SOUTH AMERICA, 13, where cross-currency exchange rates, 38 on cards 9 and 13, are included. The spot rate, 36, appears on the card as units foreignA currency/one US dollar and units USD/1 unit foreignA currency. This represents the foreignA currency value of one US dollar and the US dollar value of one unit foreignA currency. The cross-currency exchange rate appears on the card as the currency value 1 unit foreignA/1 unit foreignB and the currency value 1 unit foreign B/1 unit foreignA. This represents the currency value of one unit of foreign currency to a second foreign currency.

The second side on the DESTINATION CARD, 6, is configured as follows:

DESTINATION ATTRACTION
LOCATION CITY AND/OR COUNTRY
COUNTRY CURRENCY
SPOT RATE DESTINATION COUNTRY CURRENCY:
(UNITS FOREIGN/1 USD AND UNIT USD/1 FOREIGN)
FA/USD USD/FA
FB/USD USD/FB
FC/USD USD/FC
FD/USD USD/FD
CROSS-CURRENCY EXCHANGE RATE:
(UNITS FOREIGNA/1 FOREIGNB AND UNITS FOREIGNB/1
FOREIGNA)
FA/FB FA/FC FA/FD
FB/FA FB/FC FB/FD
FC/FA FC/FB FC/FD
FD/FA FD/FB FD/FC
DESTINATION OVERNIGHT INTEREST RATE

FIG. 3 Four chance cards, generally designated by numeral 14, include two from the CURRENCY CARD deck, 15, and two from the INTEREST RATE CARD deck, 16. One is a BONUS PENALTY card, indicated at numeral 39. The chance cards are permanently marked on both sides. The values on the CURRENCY CARD and INTEREST RATE CARD include the location, 35, and the location currency and spot rate, 36. When the card location has more than one country currency, the CURRENCY CARD, 15, includes a cross-currency exchange rate, 38, and forward exchange rates, indicated at numeral 40, for each currency. The spot rate, 36, and forward rate, 40, appear on the card the USD value of 1 unit of Foreign and the foreign currency value of 1 USD, indicated at numeral 41. The interest rates on the CURRENCY CARD, 43, and INTEREST RATE CARD, 44, vary as daily, weekly and monthly, and by country and global. Global cards, indicated by numeral 45 in FIG. 4, identify a debt instrument and investment constraint, indicated at numeral 46 in FIG. 4, and interest rates, 44. The BONUS PENALTY card. 39, has moves and transactions, indicated at numeral 47, that are mandatory.

The second side of the CURRENCY CARD is configured as follows:

LOCATION CONTINENT and CITY AND/OR COUNTRY
COUNTRY CURRENCY
CURRENCY SPOT RATE:
(UNITS USD/1 FOREIGN AND UNITS FOREIGN/1 USD)
USD/FA FA/USD
USD/FB FB/USD
USD/FC FC/USD
USD/FD FD/USD
CROSS-CURRENCY EXCHANGE RATE:
(UNITS FOREIGNA/1 FOREIGNB AND UNITS FOREIGN B/
1 FOREIGNA)
FA/FB FA/FC FA/FD
FB/FA FB/FC FB/FD
FC/FA FC/FB FC/FD
FD/FA FD/FB FD/FC
CURRENCY FORWARD EXCHANGE RATE:
(UNITS FOREIGN A B C D/1 USD AND UNITS USD/1
FOREIGN A B C D
1 WK FWD: USD/FA B C D FA B C D/USD
2 WK FWD: USD/FA B C D FA B C D/USD
3 WK FWD: USD/FA B C D FA B C D/USD
4 WK FWD: USD/FA B C D FA B C D/USD
1 MO FWD: USD/FA B C D FA B C D/USD
2 MO FWD: USD/FA B C D FA B C D/USD
3 MO FWD: USD/FA B C D FA B C D/USD
LOCATION 5-90 DAY INTEREST RATE

The second side of the INTEREST RATE card is configured as follows:

LOCATION CONTINENT AND COUNTRY OR GLOBAL
DEBT INSTRUMENT
LOCATION OR GLOBAL INTEREST RATE
DAILY
WEEKLY
MONTHLY
CURRENCY AND SPOT RATE:
UNITS FOREIGN/1 USD AND UNITS USD/1 FOREIGN
USD/FA FA/USD
USD/FB FB/USD
USD/FC FC/USD
USD/FD FD/USD

FIG. 4 A player's hand of five cards, generally designated by numeral 48, illustrates the values necessary to the learning objective of the preferred embodiment described herein. The hand includes a choice DESTINATION CARD, 13, and four chance cards selected randomly from the CURRENCY CARD, 15, and INTEREST CARD, 16, decks. One chance card is a BONUS PENALTY CARD, 39.

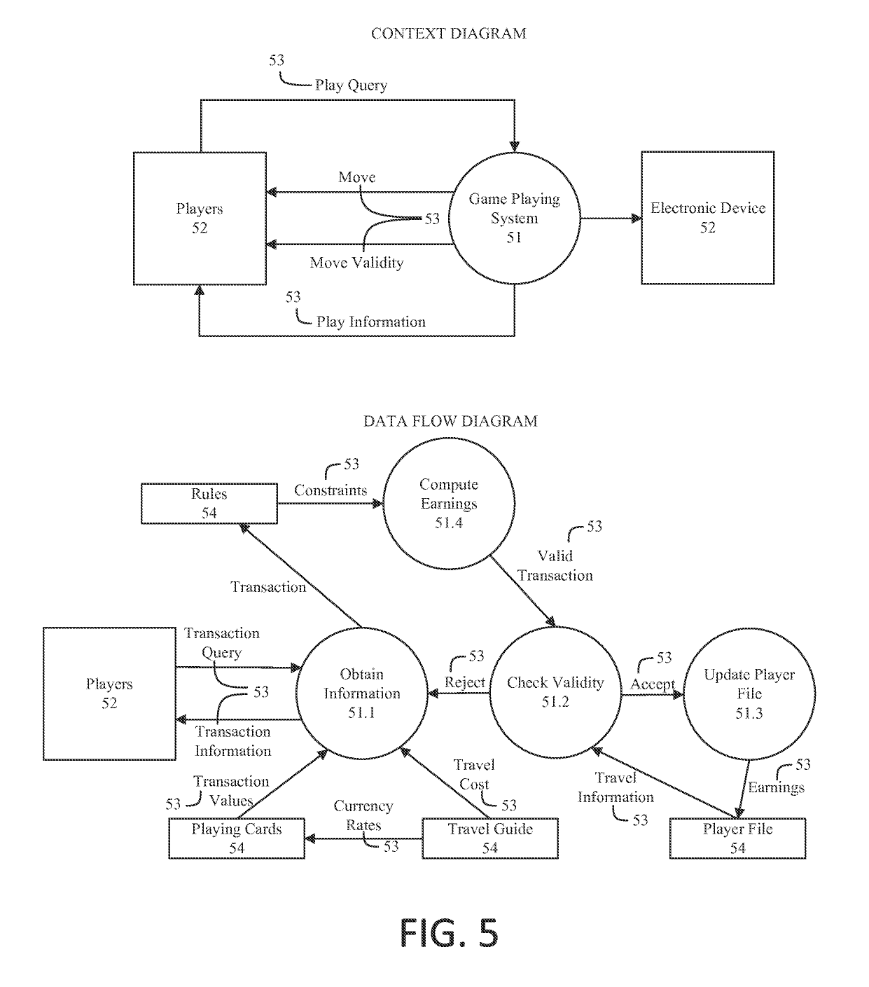

FIG. 5 DATA FLOW DIAGRAM is a representation of the components of the game board-type apparatus illustrated in FIG. 1. A data flow diagram with more detail that includes all the actions in the game will become a software program compatible to an electronic device suitable for game playing. The Context Diagram shows the game playing system as a single process and is used to produce the DATA FLOW DIAGRAM. The DATA FLOW DIAGRAM shows the major functions of the game apparatus or what the preferred embodiment of the present invention does. The diagram symbols and their meanings are a circle that shows a process and includes a verb and an object explaining what the game system does. An arrow that shows a data flow into or out of the process. Parallel lines that show a data store such as a data file or database. A square that shows an external entity that is a source from which the game playing system draws data and a source that receives information from the system. So that data flow diagrams are easy to understand and convert into software program code, the components are described in further detail in a data dictionary that describes the diagram's logic to a human rather than to a computer. For example, compute earnings would be described as a sequence of actions and instructions for carrying out the actions and would include the specific currency rate values and arithmetic involved, the data store to be read to obtain the values for computation, the action to add the transaction earnings to the players score and the information to be deleted as a result of the transaction as well as alternative courses of action.

In the Context Diagram what the game system does is reduced to one process, the game playing system, numeral 51. The external entities from which the system draw and receive system data, designated by numeral 52, are the players and their electronic playing device. Play query, play information, player move and move validity is the data flow, numeral 53, into and out of the process, numeral 51.

The DATA FLOW DIAGRAM begins to refine the game process system and has four processes, obtain transaction information, numeral 51.1, check validity, numeral 51.2, update player file, numeral 51.3 and compute earnings, numeral 51.4. The data stores, designated by numeral 54, are rules, playing cards, travel guide, and player file provide the game playing system information. The data flow arrows, numerals 53, show the movement of data between the system processes, numerals 51, and one external entity, 52, the player. Subsequent levels of the data flow diagram will be obtained by refining individual processes whose complexity warrant it into separate data flow diagrams. For example, check validity would show a data flow of transactions for a known player to processes of evaluate currency in hand and evaluate credit availability. The final stage in the refined system will become the software program for the electronic device, 52, in the context diagram of the preferred embodiment of the board-type game apparatus of the present invention, FIG. 1.

The method of playing the game referred to in the foregoing detailed description, and illustrated in the RULES OF THE GAME. FIG. 1E. 56, involves the following steps:

1. A plurality of players, preferably two to six, given $10,000 in United States currency, choose a playing piece, FIG. 1C, an expense per mile rate of travel, FIG. 1E, 62, and a start/finish destination. The start and finish destination can be a destination already mapped on the game playing field surface, FIG. 1, 2, or a new destination the player adds to the markable map surface. Players can plan their own trip or choose a tour from the TRAVEL GUIDE, FIG. 1E, 57. Players who choose a tour must follow the tour itinerary or they are eliminated from the tour. If eliminated, they can still win the game with their Round ONE score or they can choose to continue in the game by planning their own trip. Players can be individuals or groups. If players choose to group, they play the game as one player.

2. The youngest player begins the game by choosing a hand of cards, FIG. 4, one choice card, a DESTINATION CARD, 13, and four chance cards, including two cards picked randomly from the CURRENCY CARDs, 15, and two cards from the INTEREST RATE CARDs, 16. Rotating to the left the other game players similarly choose a hand of cards.

3. Each round, players use the measuring device, FIG. 1B, to measure the distance in miles to their destination, mark their route on the game playing field map with their playing piece, FIG. 1D, and calculate their travel expense in US dollars, miles traveled multiplied by the travel rate. Players must convert the US dollar travel expense amount into destination currency. Transactions are made from the values on the cards in their hand to calculate and earn back this travel expense.

Each round, players record their game play in their TRAVEL LOG, FIG. 1E, 55, their travel destination, mileage, currency transactions, expenses, earnings and calculate their score.

Maximum borrowing of $100,000 or equivalent units of foreign currency with 10% as collateral for the term of the loan.

Play continues until one player has visited the seven continents and earned back their travel expense. If one player does not meet these criteria in 90 days, eighteen rounds of play, the player with the highest score, US dollar value of currency in hand, wins the game.

Important to the preferred embodiment are the game playing cards. There are a sufficient number of playing cards to enable six players to complete eighteen rounds of play. The transaction values on the cards are derived from the learning objective, the covered interest differential in the preferred embodiment of the present invention. Forward exchange and lending and borrowing rates become less available for transactions as the game progresses. Understanding and applying the learning objective to card transactions will lead to winning the game. The transaction values on these cards are configured to allow players to earn at least $10,000 within the 90 day time frame. The cards represent real and hypothetical world currencies. By way of example and not as limitation the game cards may include the information described herein.

A player who randomly picks the following chance INTEREST RATE CARD

GLOBAL PRIVATE LENDING FUND
15 day Individual and Corporate Notes
1,000 Currency Unit Minimum Investment
A 5%
B 10%
C 12%
E 15%
F 18%
G 20%
Currency: US dollar USD $ and Euro EUR €
Spot Rate:
$1.00/USD USD/1 USD
$.50/EUR €2/USD

can buy $1,000 of G Notes earning $200 in three rounds. Higher earnings are a possibility by exchanging the dollars for euros, earning 400 euros, and selling the euros at a favorable rate.

Ten percent of the chance cards are a BONUS PENALTY CARD that can result in a gain or a loss of currency and/or time. If the player who invested in the G Notes picks the following BONUS PENALTY CARD within the next three rounds they would lose 90% of the investment.

GLOBAL PRIVATE LENDING FUND
G NOTE RECALL AT 10% OF FACE VALUE

While the ability to quickly and accurately calculate the possibilities for earnings allows for earning the expense requirement within the first few rounds of game play, players still must travel to the seven continents to win the game and must comply with mandatory chance cards—that can result in their winning or losing the game. For example,

YOUR TICKET IS PASSENGER
ONE MILLION
YOUR AIRLINE HAS AWARDED YOU
A WORLD TRIP IN A WEEK
ALL EXPENSES PAID
WINNER OF THE GAME

SHOULD HAVE SKIPPED THAT FREE
SAILING ADVENTURE
CAPTURED BY PIRATES
OUT OF THE GAME

Currently, foreign exchange trading between banks and financial institutions is in amounts of SI million or more. Given specific formulas, forward exchange rates are based on points. The smallest typical point is 0.0001 which is added or subtracted from the spot rate to determine a forward rate. With billions of dollars being traded each day this makes a difference. Similarly, overnight interest rates are a fraction of a percentage and apply to other banks and large non-bank financial institutions and transfers of millions of dollars. To demonstrate this earnings potential in the game where players are day trading with $10,000, the smallest typical point has been increased four digits to 1 or a fraction thereof and the rates on the cards are flat or fixed rates at the value given not points subtracted or added to the rate. Similarly, the interest rates, in particular the overnight rates reflect the highest historical prime lending rates recorded for the countries.

In economic theory, the difference in interest rates should be equal, but opposite in sign, to the forward exchange premium or discount between currencies. There would be no gain in trading US dollars for foreign currency since the outcome from interest earnings or forward currency exchange is the same. There would be no arbitrage opportunities or need for understanding the covered interest differential.

The unpredictability of currency exchange and interest rates has been the subject of academic research in the social sciences. Since the early 1970s, the currencies of countries with high interest rates have tended to cost less, allowing for gains when trading currency. In the described embodiment of the present invention, the transaction values on the game playing cards reflect this unpredictability. In the game of the present invention as in the real world, a forward contract only requires 10% at the time of contract. 90% of the contract can be earning interest for the term of the contract.

The currency rates in the preferred embodiment of the present invention reflect the “roller coaster ride” term used to define current fluctuations in exchange rates. Similarly, the interest rates do not differentiate by lending and borrowing. In reality, lending rates can exceed deposit rates by 50% or more and vary by purpose. While the transaction values are comprised of exaggerated rates rarely possible in the existing exchange markets, the process in the game and the real world are the same.

To enhance the learning aspect, the cards can be revised to more realistically reflect existing world currencies and currency values.

Advantages of the game apparatus of the present invention, the low cost of manufacture, the reusable game board-type surface and ease of storage and transport, make it affordable and efficient to the buying public.

The many specificities in the above detailed description are an example of the preferred embodiment. Many other variations will occur to one having ordinary skill in the art. All changes and modifications within the scope of the invention as herein described are intended to be protected.

1. An amusement and teaching apparatus, specifically a board-type game for a plurality of players, comprising:
a playing field surface having a measureable graphic with a plurality of demarcated regions;
a measuring device that measures distance between the plurality of demarcated regions on the playing field surface;
a plurality of playing pieces, each characterized by a different erasable color element, that mark game play;
a first plurality of playing cards, characterized by a first type corresponding to a demarcated region;
a second plurality of playing cards characterized by a second type different than the first type and corresponding to a demarcated region;
a third plurality of playing cards characterized by a third type different than the first type and the second type;
a game guide rules and log comprising the game playing system data;
a portable storage container configured to enclose the game playing components;
whereby the game playing components are constructed of a treated polypropylene film characterized by the properties of durability, flexibility, adherence, permanent and erasable markability and portability.

2. (canceled)

3. The board-type game of claim 1, wherein said playing field surface map graphic is a world map constructed to enable measuring and marking a route between destinations located on the plurality of demarcated regions on the graphic.

4. A device that measures world distance comprising
a horizontal base portion comprising a first plurality of indices, the first plurality of indices measuring distance between the pluralities of demarcated regions in accordance with a first distance scale;
a first diagonal portion disposed at an angle from the center of the base portion and comprising a second plurality of indices, the second plurality of indices measuring the distance between the plurality of demarcated regions in accordance with a second distance scale, the second distance scale being different than the first distance scale; and,
a second diagonal portion next to the first diagonal portion disposed at an angle from the center of the base portion, the angle of the second portion being equal in angle to the base as the angle of the first diagonal portion, and comprising a plurality of indices measuring the distance between the pluralities of demarcated regions in accordance with the distance scale of the first diagonal portion.

5. (canceled)

6. The board-type game of claim 1, wherein the first type of the first plurality of playing cards is a destination type; and,
wherein each of the first plurality of playing cards of the destination type identify one or more of the plurality of demarcated regions of the playing field surface.

7. The playing cards of claim 6, wherein the first plurality of playing cards have destination currency and interest rate transaction values on the second side of the card.

8. The board-type game of claim 1, wherein wherein the second plurality of playing cards are identified on the first side as a currency type and interest rate type that identify on the second side one or more currency exchange rates and interest rates that correspond to the plurality of demarcated regions of the first type.

9. The board-type game of claim 1, wherein the third plurality of playing cards is a type characterized by bonus and penalty transactions.

10. (canceled)

11. (canceled)

12. (canceled)

13. (canceled)

19. A method of playing a board-type game for amusement and teaching for a plurality of players comprising a playing field surface with a plurality of demarcated regions, a measuring device, playing pieces, playing cards, rules, guide, log and portable storage container, the method comprising:
adhering:
the playing field surface to an accessible play location;
recording in the log:
a travel expense rate;
a start and end destination corresponding to a first of the plurality of demarcated regions of the playing field surface;
an initial currency value recorded in the guide;
selecting:
one playing card from the first plurality of playing cards identifying a destination corresponding to one of the plurality of demarcated regions of the playing field surface;
two playing cards from the second and third plurality of playing cards identifying one or more currency exchange rates and interest corresponding to one of the plurality of demarcated regions of the playing field surface and bonus and penalty transactions;
recording in the log:
intervening destinations corresponding to a second of the plurality of demarcated regions of the playing field surface; and,
measuring with the measuring device:
the distance in miles between the intervening destinations chosen from the plurality of demarcated regions on the playing field surface;
calculating:
a travel expense based on the measured distance and the chosen travel expense rate;
converting:
the calculated travel expense to the currency of the chosen destination;
calculating:
an earnings value based on the one or more currency exchanges rates and the one or more interest rates recorded on the cards and in the guide;
recording in the log:
the chosen destinations, the distance in miles between the destinations, the travel expense value, the earnings value, and a new currency value;
demonstrating:
game play by marking player choices with the playing piece on the playing field surface, game cards and log.

20. The method of claim 10, wherein the plurality of demarcated regions on the playing field surface are permanent and erasable marked destinations on a plurality of continents on the plurality of demarcated regions.

22. The method of claim 10, wherein measuring the distance between the intervening destinations on the plurality of demarcated regions includes adhering the device to the playing field surface and marking a path between destinations using one of the plurality of playing pieces and the measuring device.

23. The method of claim 10, wherein the method comprises successive rounds of play until a predetermined number of rounds is reached.

24. The method of claim 10, wherein within a predetermined number of successive rounds of play rounds are repeated until a player's destinations include a destination on each of the plurality of continents on the plurality of demarcated regions and the new currency value is greater than or equal to the initial currency value.

25. The method of claim 10, wherein the game playing system can be translated into software for game play on an electronic device.

14. The game of claim 1, wherein said portable storage container comprises a plurality of separately sealable cylindrical compartments.

15. The portable storage container of claim 14, wherein the plurality of separately sealable compartments comprise three attachable, cylinders dimensioned to store the elements of the board-type game and constructed of a durable lightweight material with a flexible handle; and,
wherein the cylinders are sealed by a helical screw structure.

16. (canceled)

17. (canceled)

18. (canceled)
